(19) United States
(12) Patent Application Publication
(10) Pub. No.: US 2016/0293117 A1
(43) Pub. Date: Oct. 6, 2016

(54) LIQUID CRYSTAL DISPLAYS AND METHODS FOR ADJUSTING BRIGHTNESS AND CONTRAST THEREOF

(71) Applicant: SHENZHEN CHINA STAR OPTOELECTRONICS TECHNOLOGY CO., LTD, Guangdong (CN)

(72) Inventor: Ming LIU, Shenzhen, Guangdong (CN)

(21) Appl. No.: 14/440,107

(22) PCT Filed: Dec. 26, 2013
(86) PCT No.: PCT/CN2013/090606

§ 371 Date: May 1, 2015

(30) Foreign Application Priority Data
Dec. 23, 2013 (CN) 201310720117.2

(51) Int. Cl. G09G 3/36; G09G 3/20

(52) U.S. Cl. CPC G09G 3/36; G09G 3/2003; G09G 2320/0233; G09G 2320/0242; G09G 2320/0626; G09G 2320/066

(57) ABSTRACT

A liquid crystal display including a plurality of display areas, signal input modules, signal output modules and a signal comparison module, wherein each signal input module is connected with the corresponding display area to introduce a display drive signal thereto, each signal output module is connected with the corresponding display area to output respectively from the signal source the display drive signal to generate images or videos, the signal comparator module is connected with the signal output modules to compare respectively among signals output from each output signal source, if a difference is shown thereof, current value of the display drive signal is adjusted according to said difference to continuously decrease the differences of the current values of the display areas and to generate new output signals for the display areas to display thereon, so that brightness and contrast of images or videos in each display area are closely identical.

### FIELD OF THE INVENTION

The present invention relates to liquid crystal displays (LCD) and adjustment methods thereof, and more particular, refers to adjustment methods making brightness and contrast identical for large-size liquid crystal displays.

### BACKGROUND OF THE INVENTION

Currently, most television screens' type is liquid crystal display (LCD), LCD structure includes a liquid crystal panel, backlight structure and a drive circuit, etc. The drive circuit is connected to an external power supply and signals to convert voltage of the external power supply into drive voltage range of the liquid crystal panel, and also to convert the external signals into identifying signals displayed by the liquid crystal panel.

Drive modes of most liquid crystal panels are single-circuit mode, that the liquid crystal panels is square and has four sides including two long sides and two short sides thereof, the four sides surround to form a whole display panel. The display panel is driven by a drive interface, i.e., a line of a circuit starts from a positive electrode, goes through the panel, and goes around until arriving to a negative electrode of the drive interface, so current of the circuit between the positive electrode and the negative electrode flows through the entire panel.

Since the circuit of the panel has some impedance, the current would be gradually decayed through the entire panel, which causes one half display area to be a bright side, the other half display area to be a dim side by comparison, and as a result brightness and color are different between left and right side (or upper and lower) on the screen, thereby causing poor display effect.

### SUMMARY OF THE INVENTION

On account of the lack of the prior art, an object of the present invention is to provide a LCD of which each display area shows identical brightness and contrast, thereby avoiding certain local areas being too bright or too dark and different shades on large-size displays.

The present invention provides a LCD being set with a plurality of display areas, signal input modules, signal output modules and a signal comparison module, wherein each said signal input module is electrically connected with the corresponding display area to introduce a display drive signal thereto, each said signal output module is electrically connected with the corresponding display area to output respectively from the signal source a display drive signal of corresponding display area to generate images or videos. The signal comparator module is electrically connected with the signal output modules to compare respectively among signals output from each output signal source of each display area. The comparison among signals output from each output signal source of each display area takes place in the signal comparison module to obtain signal comparison results. If there is a difference between any two signals, current value of one display drive signal should be adjusted according to the difference, by this method, the differences of the current values of each display area could be continuously decreased, a new output signal could be generated and then to be displayed in the display area, so that the brightness and contrast of the images or videos in each display area should be closely coincident.

Preferably, each said display area is disposed with at least one adjustable resistance or adjustable capacitance. The output current values of each display area could be adjusting by changing values of the adjustable resistance or capacitance to change the brightness and the contrast of the output signal sources. Said display areas are set respectively on different liquid crystal panels.

Preferably, the signal comparison results comprise marked information of the display area that is corresponding to the output signal source.

The present invention also provides a method for adjusting brightness and contrast of a liquid crystal display, comprising following steps of:

Step 1) inputting respectively display drive input signals from signal input modules to their corresponding display areas;

Step 2) outputting respectively display drive signals from output signal sources to corresponding display areas to generate images or videos;

Step 3) comparing the output signals of each display area in a signal comparison module to obtain signal comparison results, If there is a difference between any two signals, current value of the display drive signal should be adjusted according to the difference to continuously decrease the differences of the current values of each display area, thus to generate a new output signal to the display area to display, so that the brightness and the contrast of the images or videos in each display area should be closely coincident.

Wherein, in step 1) setting a display region comprising a half screen A and a half screen B;

In step 2) outputting a first frame of data of the half screen A by the display drive signal via the half screen A, and outputting a first frame of data of the half screen B via the half screen B;

Step 3) obtaining a first difference in the signal comparison module by comparing the first frame of data of the half screen A and the first frame of data of the half screen B, and adjusting the current value according to the first difference, then to subtract the first difference from the current value of the display area having higher brightness or contrast, thereby making the brightness and the contrast of the images or the videos of the both half displays be closely identical.

In a preferred embodiment of the present invention, further comprising a step 4): outputting and displaying the display drive signals by each half display after correcting the display drive signals introduced respectively into the half screens A and B according to the first frames of data of the half screens A and B; obtaining a second difference in the signal comparison module by comparing a second frame of data of the half screen A and a second frame of data of the half screen B, and adjusting the current values according to the second difference, then to subtract the second difference from the current value of the display area having higher brightness or contrast, thereby making the brightness and the contrast of the images or the videos of the both half screens be closely identical.

Wherein the difference between the output signal sources of the half screens A and B is diminished progressively, and a latter difference is less than a previous difference.

Compared with the prior art, in the display dividing treatment of the present invention, the large size screen is divided into certain half screens, each half screen is adjoined seamlessly and set with adjustable resistances or capacitances, the current could be changed by adjusting the adjustable resistances or capacitances, and the output signals of the output signal sources of each half display are compared, so the current of the corresponding half screen would be adjusted according to the difference of the previous frames of the two half screens, and the brightness or the contrast of the screen is increased by increasing the current, and vice versa reduced. The contrast and the brightness values of each of the display area could be individually adjusted by said automatic feedback and adjustment process. Moreover, the brightness and the contrast of upper and lower, left and right regions of the panel could be identical and thus images and videos could be displayed evenly by maintaining the brightness and the contrast of each independent display panel uniform.

### BRIEF DESCRIPTION OF THE DRAWINGS

FIG. 1 is a circuit block diagram showing a display drive signal adjusting circuit of a liquid crystal display of the present invention; and

FIG. 2 is a flow diagram showing a process for controlling signal sources of a liquid crystal display of the present invention.

### DETAILED DESCRIPTION OF THE PREFERRED EMBODIMENTS

In order to adjust in real-time brightness of each area on liquid crystal displays to maintain uniform brightness in the areas and thus to avoid color or brightness differences in certain local areas, the present invention provides a liquid crystal display in which display drive signals input into the liquid crystal display could be adjusted, and a method for controlling signal sources.

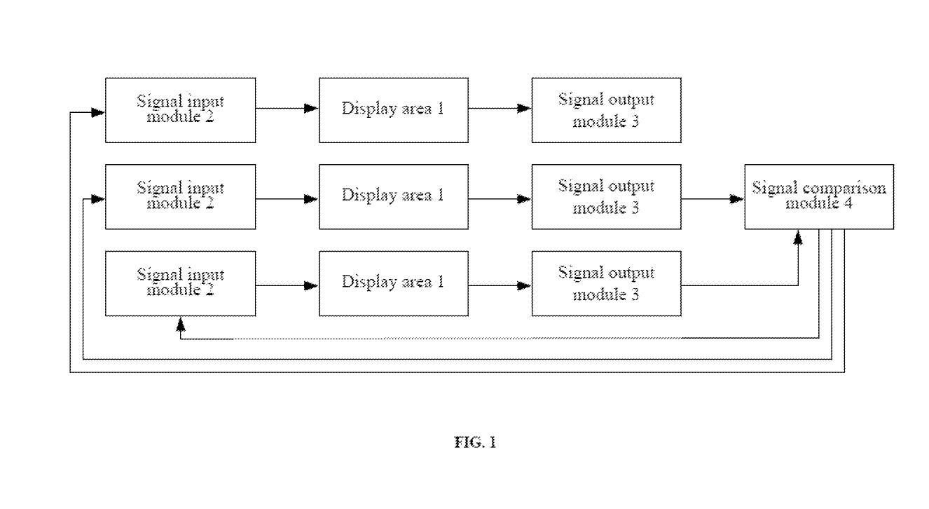

Please refer to FIG. 1, the present invention provides a liquid crystal display, including a plurality of display areas 1, signal input modules 2, signal output modules 3 and a signal comparison module 4. Wherein each signal input module 2 is connected electrically with a corresponding display area 1 to input display drive signals thereto. Each signal output module 3 is connected electrically with a corresponding display area 1 to output display drive signals via an output signal source in a corresponding display area to generate images or videos. The signal comparison module 4 is connected electrically with the output modules 3 to compare respectively signals of the output signal sources of the display areas, and the comparison of the output signal sources of the display areas takes place in the comparison module 4 to obtain comparison results. If there is a difference between any two signals, current value of the display drive signal should be adjusted according to the difference to continuously decrease the differences of the current values of each display area, thus to generate a new output signal in the display area to be displayed, so that the brightness and the contrast of the images or videos in the display areas should be closely identical.

Wherein the said display areas 1 are mutually separated by dividing a panel into several separate sub-panels, and each display area locates respectively in a corresponding sub- panel. Each display area 1 abuts against each other to maintain continuity of display image. The sub-panels are divided according to the overall size of screen. The brightness and the contrast of the outputting images or videos in each display area could be corrected by adjusting the current input to the screen. The signal comparison result contains marked information corresponding to a display area of an output signal source, i.e., the marked information to be adjusted, such as to increases brightness value of a display area at the third column and the second row. The parameter about the brightness is indicated by a voltage value.

In the present invention, at least one adjustable resistance or capacitance is provided in each display area, thereby changing the output current value of each display area by changing the values of the resistance or capacitance. More specially, on one hand, the resistance value increases, the current value decreases correspondingly, so they are in an inversely proportional relationship; on the other hand, the capacitance value increases, the current value and a consequence also increases, so they are in a positive proportional relationship. If images or videos output from certain half screen are much bright, it should reduce the current value of the half screen and input new display driver signals, thus to darken the images or videos output from the corresponding half screen. By this way, the brightness and the contrast of each half screen tend to be identical, thereby avoiding the phenomenon that some local color shown on the display panel is too deep or the other local color thereon is too light.

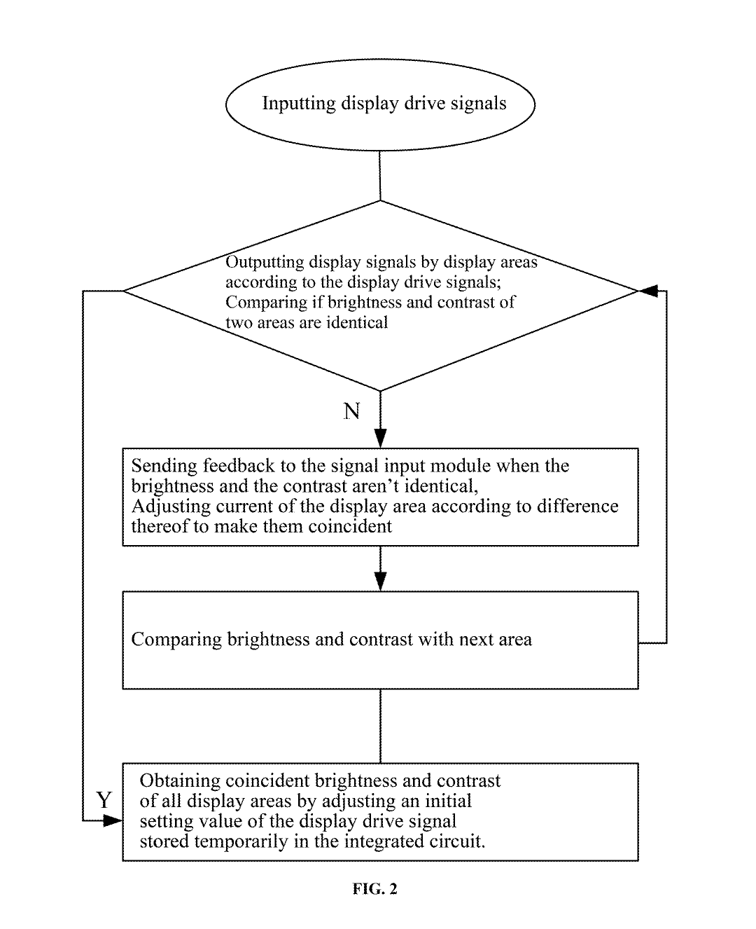

Referring to FIG. 2, the present invention also provides a method for adjusting brightness and contrast of a liquid crystal display, including following steps of:

Step 1) inputting display drive input signals from each signal input module 2 to a corresponding display area 1;

Step 2) outputting the display drive signals in their corresponding display areas 1 from output signal sources to generate images or videos;

Step 3) comparing output signals of each said display area 1 in a signal comparison module 4 to obtain signal comparison results. For the signal comparison results, if there is a difference between any two signals, current value of the display drive signal should be adjusted according to the difference to continuously decrease the differences of the current values of the display areas 1, thus to generate new output signals for the display areas 1 to display thereon, so that the brightness and the contrast of images or videos in each display area 1 should be closely identical. If there isn't a difference between any two signals, the identical brightness and contrast of the display areas might be obtained by adjusting an initial setting value (current value or voltage value) of the display drive signal stored temporarily in the integrated circuit.

Wherein, in step 1) setting the display area with a half screen A and a half screen B; further, setting the display area according to overall size of the display, and then, identifying each half screen to adjust brightness and contrast of corresponding screen.

In step 2) outputting a first frame of data of the half screen A by the display drive signal via the half screen A, and outputting a first frame of data of the half screen B via the half screen B; the first frames of data include data of images or videos.

Step 3) obtaining a first difference in the signal comparison module by comparing the first frame of data of the half screen A and the first frame of data of the half screen B, adjusting the current value according to the first difference, then to subtract the first difference from a current value of another display area having higher brightness or contrast, thereby making the brightness and contrast of images or videos of the both half screens be closely identical.

In a preferred embodiment of the present invention, further including a step 4): outputting and displaying the display drive signals by each half screen after correcting the display drive signals introduced respectively into the half screens A and B according to the first frames of data of the half screens A and B; obtaining a second difference in the signal comparison module by comparing a second frame of data of the half screen A and a second frame of data of the half screen B, and adjusting the current value according to the second difference, then to subtract the second difference from the current value of a display area having higher brightness or contrast, thereby making the brightness and the contrast of images or videos of the both half screens be closely identical.

Wherein the difference between the output signal sources of the half screens A and B could be decreased progressively, and the second difference should be less than the first one, and so on, the adjustment would be stopped once the differences of the brightness and the contrast are down to zero by the continuously narrowing.

A uniform process of the display drive signal of each screen will be specified by a following embodiment.

Assume that the screen is divided into two halves, namely half screen A and half screen B. Currently, the signal sources transmit image information by the way of frame by frame. Assume when a first frame of a display driver signal is transmitted to the screen, the half screen A and the half screen B might display as a whole at this moment, but since brightness, contrast and other parameters of the two halves screen are respectively unequal, and output signal sources including parameters such as the brightness and the contrast should be output to the signal comparison module by respective signal output modules, then, two sets of data would be shown in the signal comparison module, wherein one set includes display parameters such as the brightness and the contrast, etc. of the half screen A and data thereof is set as a first frame of data of the half screen A; the other set includes display parameters such as the brightness and the contrast, etc. of the half screen B and data thereof is set as a first frame of data of the half screen B. A second frame of data of the half screen A and a second frame of data of the half screen B will be presented in the signal comparison module when a next output signal source output signals. In this case, the signal comparison module compares the first frame of data of the half screen A and the first frame of data of the half screen B to result in a difference C1, and then to reduce (or increase) the C1 of the first frame of data of the half screen A (or the first frame of data of the half screen B). Thereafter, the first frame of data of the half screen A is compared with the second frame of data of the half screen B to result in a difference C2, and then to reduce (or increase) the C2 of the first frame of data of the half screen A (or the first frame of data of the half screen B), and such adjustment would be continued. The adjustment should be stopped until the differences are 0 to ultimately make the brightness and the contrast of images or videos output from the half screen A and the half screen B consistent.

Compared with the prior art, the display divided treatment of the present invention in which the large size screen might be divided into certain half displays, each half display is adjoined seamlessly and set with at least on adjustable resistance or capacitance, the current is changed by adjusting the resistances or capacitances, and the output signals of the output signal sources of each half screen could be compared, so the current of the corresponding half screen is adjusted according to the difference of the previous frames of the two half screens, and brightness or contrast of the screen would be increased by increasing the current, and vice versa reducing. The contrast and brightness values of each of the display area can be individually adjusted by said automatic feedback and adjustment process. Moreover, brightness and contrast of upper and lower, left and right regions of the panel could be identical and thus images and videos could be displayed evenly by maintaining the brightness and the contrast of each independent display panel uniform.

What is claimed is:

1. A liquid crystal display, comprising a plurality of display areas, signal input modules, signal output modules and a signal comparison module, wherein each said signal input module being electrically connected with the corresponding display area to introduce a display drive signal thereto, each said signal output module being electrically connected with the corresponding display area to output respectively from the signal source the display drive signal of corresponding display area to generate images or videos, said signal comparator module being electrically connected with the signal output modules to compare respectively among signals output from each said output signal source of each said display area, wherein each said display area being disposed with at least one adjustable resistance or at least one adjustable capacitance, output current value of each said display area being adjusted by changing values of said adjustable resistance or said adjustable capacitance, said output signal sources of said display area being compared in said signal comparison module to obtain a signal comparison result, if a difference being shown thereof, current value of said display drive signal being adjusted according to said difference to continuously decrease the differences of said current values of said display areas and to generate new output signals for said display areas to display thereon, so that brightness and contrast of images or videos in each said display area being closely identical.

2. The liquid crystal display according to claim 1, wherein each said display areas is set respectively in a different liquid crystal panel.

3. The liquid crystal display according to claim 2, wherein said signal comparison results comprise marked information of said display area being corresponding to said output signal source.

4. A method for adjusting brightness and contrast of a liquid crystal display, comprising following steps:
Step 1) inputting respectively display drive input signals from signal input modules to their corresponding display areas, setting a display area comprising a half screen A and a half screen B;
Step 2) outputting respectively display drive signals from output signal sources to corresponding display areas to generate images or videos, outputting a first frame of data of said half screen A by said display drive signal via said half screen A, and outputting a first frame of data of said half screen B via said half screen B; and
Step 3) comparing said output signals of each said display area in a signal comparison module to obtain signal comparison results, if there is a difference between any two signals, current value of the display drive signal is adjusted according to the difference, obtaining a first difference in said signal comparison module by comparing the first frame of data of the half screen A and the first frame of data of the half screen B, and adjusting the current value according to the first difference, then to subtract the first difference from the current value of the display area having higher brightness or contrast to continuously decrease the differences of the current values of each display area, thus to generate a new output signal to the display area to display, so that the brightness and the contrast of the images or videos in each display area should be closely coincident.

5. The method for adjusting brightness and contrast of a liquid crystal display according to claim 4, further comprising:
step 4): outputting and displaying display drive signals again by each half display after correcting the display drive signals introduced respectively into the half screens A and B according to the first frames of data of the half screens A and B, obtaining a second difference in the signal comparison module by comparing a second frame of data of the half screen A and a second frame of data of the half screen B, and adjusting the current values according to the second difference, then to subtract the second difference from the current value of the display area having higher brightness or contrast, thereby making the brightness and the contrast of the images or the videos of the both half screens be closely identical.

6. The method for adjusting brightness and contrast of a liquid crystal display according to claim 5, wherein said difference between the output signal sources of said half screens A and B is diminished progressively, and a latter difference is less than a previous difference.

7. The method for adjusting brightness and contrast of a liquid crystal display according to claim 5, wherein each said display area being disposed with at least one adjustable resistance or at least one adjustable capacitance, output current value of each said display area being adjusted by changing values of said adjustable resistance or said adjustable capacitance.

8. A liquid crystal display, comprising a plurality of display areas, signal input modules, signal output modules and a signal comparison module, wherein each said signal input module being electrically connected with the corresponding display area to introduce a display drive signal thereto, each said signal output module being electrically connected with the corresponding display area to output respectively from the signal source the display drive signal of corresponding display area to generate images or videos, said signal comparator module being electrically connected with the signal output modules to compare respectively among signals output from each said output signal source of each said display area, wherein said output signal sources of said display area being compared in said signal comparison module to obtain a signal comparison result, if a difference being shown thereof, current value of said display drive signal being adjusted according to said difference to continuously decrease the differences of said current values of said display areas and to generate new output signals for said display areas to display thereon, so that brightness and contrast of images or videos in each said display area being closely identical.

9. The liquid crystal display according to claim 8, wherein each said display area is disposed with at least one adjustable resistance or at least one adjustable capacitance, output current value of each said display area being adjusted by changing values of said adjustable resistance or said adjustable capacitance.

10. The liquid crystal display according to claim 8, wherein each said display areas is set respectively in a different liquid crystal panel.

11. The liquid crystal display according to claim 8, wherein said signal comparison results comprise marked information of said display area being corresponding to said output signal source.

12. A method for adjusting brightness and contrast of a liquid crystal display, comprising following steps:
Step 1) inputting respectively display drive input signals from signal input modules to their corresponding display areas;
Step 2) outputting respectively display drive signals from output signal sources to corresponding display areas to generate images or videos; and
Step 3) comparing said output signals of each said display area in a signal comparison module to obtain signal comparison results, if there is a difference between any two signals, current value of the display drive signal is adjusted according to the difference, the differences of the current values of each display area are continuously decreased to generate a new output signal to the display area to display, so that the brightness and the contrast of the images or videos in each display area should be closely coincident.

13. The method for adjusting brightness and contrast of a liquid crystal display according to claim 12, wherein:
in step 1) setting a display area comprising a half screen A and a half screen B;
in step 2) outputting a first frame of data of the half screen A by the display drive signal via the half screen A, and outputting a first frame of data of the half screen B via the half screen B.

14. The method for adjusting brightness and contrast of a liquid crystal display according to claim 13, wherein:
step 3) obtaining a first difference in the signal comparison module by comparing the first frame of data of the half screen A and the first frame of data of the half screen B, and adjusting the current value according to the first difference, then to subtract the first difference from the current value of the display area having higher brightness or contrast, thereby making the brightness and the contrast of the images or the videos of the both half displays be closely identical.

15. The method for adjusting brightness and contrast of a liquid crystal display according to claim 14, further comprising:
a step 4): outputting and displaying the display drive signals by each half display after correcting the display drive signals introduced respectively into the half screens A and B according to the first frames of data of the half screens A and B, obtaining a second difference in the signal comparison module by comparing a second frame of data of the half screen A and a second frame of data of the half screen B, and adjusting the current values according to the second difference, then to subtract the second difference from the current value of the display area having higher brightness or contrast, thereby making the brightness and the contrast of the images or the videos of the both half screens be closely identical.

16. The method for adjusting brightness and contrast of a liquid crystal display according to claim 15, wherein said difference between the output signal sources of the half screens A and B is diminished progressively, and a latter difference is less than a previous difference.

17. The method for adjusting brightness and contrast of a liquid crystal display according to claim 15, wherein at least one adjustable resistance or at least one adjustable capacitance is provided in each said display area, current value is changed by the adjustment of the adjustable resistance or capacitance.
